(19) United States
(12) Patent Application Publication
(10) Pub. No.: US 2023/0187757 A1
(43) Pub. Date: Jun. 15, 2023

(54) Modular series-connected battery pack (BlMoSe)

(71) Applicant: LIMATECH, TOULOUSE (FR)

(72) Inventors: Luc POUYADOU, BRIGNOUD (FR); Maxime DI MEGLIO, SAINT ORENS (FR); Florence ROBIN, SAINT ORENS (FR)

(21) Appl. No.: 17/928,658

(22) PCT Filed: Jul. 23, 2021
(86) PCT No.: PCT/EP2021/070670

§ 371 Date: Nov. 30, 2022

(30) Foreign Application Priority Data
Jul. 27, 2020 (FR) FR2007906

(51) Int. Cl. H01M 50/258; H01M 10/052; H01M 10/48; H01M 10/42; H01M 10/6571; H01M 50/509; H02J 7/00

(52) U.S. Cl. CPC H01M 50/258; H01M 10/052; H01M 10/482; H01M 10/425; H01M 10/6571; H01M 10/486; H01M 50/509; H02J 7/0013; H02J 7/0047; H01M 2010/4271

(57) ABSTRACT

The subject matter of the present invention is a modular series-connected battery pack (BIMoSe) consisting of lithium battery cells having the same characteristics, connected in series by connections in a given direction (S) corresponding to the direction of the currents in order to obtain the necessary voltage.

### TECHNICAL FIELD AND SUBJECT OF THE INVENTION

The present invention relates to lithium batteries and a modular series-connected battery pack (BIMoSe) made up of lithium battery cells.

### STATE OF THE ART

An external modular architecture is known in the state of the art, for example from application WO 2010/145230 A1, in which X batteries are coupled to an external bus allowing data to be uploaded to a supervisor.

According to another prior art, patent application WO2020064221 A1 teaches a battery system using a method for detecting abnormal self-discharge in a battery system comprising a plurality of lithium-ion cells and a battery management system (BMS, referred to as BCU in the figures), wherein the cells are each provided with a cell supervision circuit (CSC) or with cell modules supervising the balancing individually or in groups, and the battery management device is configured so that at the predetermined moment when a cell or group of cells, the cell voltage of which is compared with at least one other cell or group of cells and is increased, drives the balancing circuit to this cell or group of cells to be supported, and optionally draws charge from another cell or supplies a group of cells with a lower cell voltage until the cell voltages are equalized.

In the event of occasional or sporadic deviations, only one entry can be made in the fault memory of the BCU, which marks the cell to be checked during the next maintenance of the battery system.

In the case of frequent and stronger deviations, the cell can for example be marked for an upcoming exchange and the BMS transmits a corresponding message via a communication channel, for example a CAN bus, to the system in which the battery system is installed, for example an electric vehicle.

In the worst case, in the event of very large deviations from the setpoint value and/or deviations that become increasingly large, the BMS can also shut down the cell or the module in which the cell is installed to prevent further deterioration and the occurrence of an internal short circuit.

However, this document does not teach stopping a group of cells on detection of a high temperature. In addition, the cells are each provided with a balancing circuit individually or in groups, but the other functions of a management circuit are not provided, and ultimately the decision and storage unit BCU is remote.

Patent application CA 3044454 A1 teaches a set of batteries comprising several groups of cells connected in series only comprising a control mechanism in which the cut-off mechanism is in the operational position when it is powered and in the bypass position of a group of cells when it is not powered. This patent application also teaches the detection of a short circuit by a current sensor, the detection of a temperature increase in the cells, the detection of an overvoltage or an undervoltage or of a temperature exceeding a temperature threshold to perform opening of a contact producing a bypass of a set of batteries. The BMS is configured to receive external power, to communicate analog and digital signals and to communicate with external services.

This device has the drawback of requiring a current sensor. Furthermore, the cut-off mechanism is in the operational position when it is powered and in the bypass position when it is not powered. The drawback of such a device is that it causes a group of cells to be bypassed if the cut-off mechanism ceases to be powered by a circuit failure and not following detection of a temperature overrun.

In addition, the device is not powered when it is in the operational position; furthermore, it relates only to a grouping of modules in series to introduce or remove a module from the group according to certain conditions.

Also known is US patent application 2016185251 A1, which teaches a device for heating a battery by electric current creating a bidirectional current in the battery by creating charge and discharge phases, which results in raising the temperature of the battery.

However, such a device has the drawback of having to be in position to be able to create the charging phases. Indeed, the discharge phases can be obtained by putting the battery in circuit with a current-consuming device, but for the charging phases it is necessary to have a generator, which can only be operational if the engines of the vehicle or the plane are working. This system does not allow the battery to be warmed up when it is cold before starting to obtain maximum power.

There is also the patent application WO 2018095039 A1, which describes a remote intelligent battery management system, comprising: at least two battery packs, a data analysis center and a terminal monitor. Each battery pack is equipped with a set of lithium batteries, a battery management system (BMS) module, a GPS communication module and a 4G communication module. The BMS module is used to obtain the lithium battery set data and to manage the lithium battery set; the GPS module is used to obtain the location data of the geographical information of the lithium battery pack; the 4G communication module is used to transmit the lithium battery set data and the geographical information location data to the data analysis center by means of a base station; the data analysis center has a data test center, a data storage center and a cloud-based artificial intelligence battery analysis center. The remote intelligent battery management system can adjust a management policy of a BMS in real time and control the charging and discharging conditions of lithium battery sets, such that battery safety is greatly improved. By determining the operating conditions of lithium battery sets, after-sales communication costs are reduced, and the utilization rate and repair rate of lithium battery sets are improved.

In this device, the battery management module only serves to collect the measurements and send them to a data analysis center, which therefore detects and decides on the management of the Batteries.

Also known is patent application CN 110600641 A, which teaches a 48 V lithium battery system module comprising a 12-cell module, a BMS, water cooling plates and bars formed in at least one plywood plate having openings the size and shape of the cells.

Such a device teaches a modular system with plywood plates and water cooling plates. It does not provide for heating of the cells, quite the contrary.

The prior art also comprises patent application CN 109659990 A, which discloses a lithium battery safety monitoring and management system for electric vehicles comprising a BMS, a cloud server and a mobile terminal APP; the BMS comprises a micro-control unit, an acquisition module, a charge and discharge control module and a wireless transmission management module. The acquisition module, the charge and discharge control module and the wireless transmission management module are electrically connected to the micro-control unit; the acquisition module comprises a voltage sensor, a current sensor and a temperature sensor, which are used to collect battery voltage, current and temperature during use. The charge and discharge control module performs charge and discharge control according to the battery information collected by the collection module; the BMS is formally connected to the cloud server through the wireless transmission management module; the mobile terminal APP is formally connected to the cloud server. The BMS further comprises a security protection module; the security protection module is electrically connected to the micro-control unit, which is used to appear in the battery pack. Under abnormal overcharging, overdischarging, overcurrent, overheating and low temperature conditions, it alarms and cuts off the battery pack output to the load. Such a device requires a terminal and a server in the cloud to operate. It also requires a current sensor.

Also known is patent application CN 110048178 A, which relates to a device and a method for detecting a short circuit in a battery by recording the cumulative equilibrium power of each cell of the battery several times in the state of equilibrium of the battery, and recording the start time of each equilibrium of the battery. By continuously recording the equalization process data n times, and detecting the internal short circuit. Such a device requires sufficient memory capacity and calculations.

Finally, patent application KR 102065679 A teaches a protection circuit external to the battery and an over-discharge and over-charge limitation detection circuit using MOS transistors, comparators and a resistance bridge to provide a reference voltage V_{ref}.

However, the solutions of the prior art have drawbacks because they do not allow the battery to remain functional, by delivering a lower maximum current but without the voltage of the series-parallel battery being changed. Moreover, the proposed solutions describe external modular architectures that multiply the wirings, rather than an architecture internal to the battery.

The invention therefore aims to solve one or more of these drawbacks by proposing a modular series-connected battery pack (BIMoSe), of simple and economical construction while integrating the operational safety functionalities of the battery pack.

### GENERAL PRESENTATION OF THE INVENTION

To achieve this result, the present invention relates to a modular series-connected battery pack (BIMoSe) consisting of lithium battery cells arranged in a vertical direction (V); these cells with the same characteristics are connected in series by connections in a given direction (S) corresponding to the direction of the currents to obtain the necessary voltage,

The modular series-connected battery pack comprising, in the same direction (V), a pair of upper and lower holding elements for holding adjacent cells and perpendicular to the direction (S);

Wide tongues connect, on each upper or lower face of the module, each pair of adjacent cells mounted in series each with the next by their poles of opposite polarity, in the direction (S), and ensure the connections between the battery cells, said wide tongues of each upper, respectively lower, face being offset by one cell on the other lower, respectively upper, face;

The connections are also connected to a processing circuit for measuring the potentials of each cell, the circuit being mounted on a printed circuit assembly forming three surfaces arranged in a U, that is to say, with two upper and lower surfaces parallel to one another and interconnected at one end by a central surface that is perpendicular to them, said surfaces being substantially planar and the junctions between the surfaces being rounded or not. This U-shaped assembly surrounds the modular battery assembly on three sides. Said U-shaped assembly is arranged so that the perpendicular (or normal) to the central part of the U is perpendicular to the direction (S) and to the direction (V), and

the upper part of the central part of the U (that is to say, the face of the central part that is outside the U, called the outer face) contains the electronics of the modular battery pack management system (BIMoSe);

The card, forming the central part of the U, arranged vertically, comprising the heating resistors of the modular battery pack and these resistors being connected on command from the management circuit to one or more battery cells of the modular battery pack for their supply;

The lower part of the U arranged under the cells contributing, with the upper part of the U, at least to recovering the potentials of each of the cells of the modular battery pack in order to supply them to the voltage management circuit of the management system of the modular battery pack.

In one embodiment, the central part comprises temperature sensors and a thermostat.

According to one embodiment, the open/closed contact of a switching device is connected on the one hand to the positive or negative pole of each last battery cell of a modular battery pack and on the other hand to the positive or negative lug, respectively, of the battery, the switching device being a MOSFET or an electromagnetic element.

Thus, this embodiment improves the fault tolerance strategy. Indeed, the person skilled in the art knows that any system may one day fail, even with high operating security. An interesting point of the modular architecture for a battery with several modules is the ability to electrically isolate a module showing failures, thus allowing the vehicle to finish its journey with minimal damage; if a battery line is missing, the driver sees a battery fault but continues to have electricity in the vehicle.

A single module is problematic for the exchange of data between modules (both security-level information and at the commands and data monitoring level).

Thus, another object of the invention is to propose a solution to this problem.

According to this aim, each BMS card of each modular block comprises a digital bus and an analog bus that are connected to a connector allowing the buses of a plurality of cards BMSₙ belonging to a plurality of modular battery packs (BIMoSeₙ) to be connected together, then with a supervisor system (SU) of all of the plurality of modular battery packs.

According to another embodiment, the number of cells in series on a line is to be chosen from 1 to x depending on the desired voltage, the desired maximum voltage being supported by the components used in the switching device or the BMS card.

In another embodiment, the holding elements are bezels held by spacers and delimiting a set of cylindrical housings with a circular or square or polygonal section defining, on each upper or lower bezel, a line of housings each receiving a cell;

The tongues form, with elastic pins, for example of the pogo type (called pogo pin), a T whose central bar constitutes the connection between the cells and the processing circuit for recovering potentials via the upper and lower card.

Thus, by fixing the upper and lower cards on the spacers, the tongues are held on the cells by the elastic pins.

Thus, the assembly of the modular battery pack can dispense with the use of tin soldering techniques, which can pose problems of reliability of the contacts when the modular battery pack is subjected to vibrations.

The invention also relates to a series-parallel battery using modular series-connected battery packs as briefly described above, a plurality of modular series-connected battery packs BIMoSe being assembled in a row side by side and interconnected by two power bars, one of which is connected to each of the positive poles of each modular battery pack and to the negative outer lug of the battery box, and an inter-card connection makes it possible to link the buses of each card together to form a series-parallel battery connected to an internal supervisor in the battery box consisting of a microprocessor and an application program and connected to other equipment by connectors.

In one embodiment, on detection of too high a temperature of a module by the BMS card of a modular battery pack, the latter controls the disconnection of the electric battery row concerned by opening the switching device to create a degraded current operating mode for the series-parallel battery assembly, and the supervisor sends an alert message to the user (vehicle driver or pilot); then, if the temperature of the module decreases after opening the circuit, information on the drop in temperature is sent to the user. This allows the battery to remain functional in the event of overheating, without the series-parallel battery voltage being changed and possibly indicating that the incident was temporary to allow better analysis of the incident.

According to another embodiment, the switching device is connected to a bar connected to a pole line adjacent to the positive pole of the assembly, this bar acting as a passive radiator for discharging the heat from the cells by its dimensions chosen accordingly.

According to another embodiment, for a 12 V, 15 Ah battery, the series-parallel battery is made up of m rows of modular series-connected battery packs connected in parallel, each of the modular battery packs being made up of n lithium cells assembled in series (nSmP), nS designating the number of series electric accumulators and mP designating the number of parallel lines.

The invention also relates to a set of series-parallel batteries as briefly described above, the cells chosen being lithium elements of 3.3 V each and 2.5 Ah.

In one embodiment, each module of the modular series-connected battery pack comprises a set of three interconnected electronic cards, ensuring a BMS function, for managing the elements of a modular battery pack, extended to have one or more of the following features in so-called normal operation:

Cell voltage balancing;

Comparison of the voltage thresholds of each electric battery;

Supply of electric battery heaters in case of negative temperature;

Module temperature measurement managed by the BMS card;

Protection against short circuits by short circuit detection and protection against a slow and deep discharge by slow and deep discharge detection, and opening of the switching device consisting either of at least one MOSFET, or of an electromagnetic element;

Limitation of the charging current by opening the charging circuit so as to preserve the longevity of the electric batteries;

Calculation of the state of charge and health of the electric batteries;

Dialog with the circuit to send it the following information:

Alert;

SOH;

ON;

OFF;

Or to execute the following orders received from the supervisor:

ON;

OFF;

Starting the heater.

Thus, a single global BMS card makes it possible to monitor, detect and trigger either an action or information to the supervisor or both at the same time.

In another embodiment, when the supervisor detects a fault in the balancing of the currents between modules via observation by the supervisor of an electric battery line with a current out of limit, an excessive difference with respect to the others indicating that this line is fatigued, the series-parallel battery triggers the sending by the supervisor of a “maintenance” message from the battery to the driver of the vehicle or to the pilot, allowing the state of the battery to be checked and a breakdown to be avoided.

In another embodiment, the BMS card of the modular series-connected battery pack has the following reaction time characteristics:

Detection of a short circuit: opening time of 75 ms;

Detection of the maximum admissible current: opening time of 10 seconds;

Detection of a discharge corresponding to 10° C.: 10 times the capacity C of the battery, that is to say, for a 10 Ah battery, the discharge is at 100 Ah and the circuit opening time is 5 minutes 30 seconds;

Detection of a discharge corresponding to 1° C.: and in this case, the circuit opening time is 60 minutes.

According to another embodiment, each BMS card integrates temperature monitoring that remains constantly active, even if the battery is “OFF,” by analyzing the temperature in the battery envelope via the supervisor, measured by a probe mounted on the central part of the cards of each module to warn via a message on an LCD screen or by an audible beep, even when the battery is on the shelf.

According to another embodiment, to limit the charging current, each BMS card uses a component of the resistor type, which is conductive in the direction of discharge of the battery and resistive like a diode connected in opposition in the direction of charge.

According to another embodiment, the BMS cards use:
A digital data bus to transmit signals between each module:
One or more communication protocols allowing:
   Data monitoring of each module (balancing voltage, temperature, current);
   Reporting of alerts;
   Monitoring health status, state of charge.

According to a last embodiment, the component circuits are replaced where possible by the use of a microcontroller in each module and of a supervisor (either implemented in one of the modules or on a separate card internal to the battery) to allow:

The implementation of innovative algorithms, even “machine learning or deep learning” (failure management).

### PRESENTATION OF FIGURES

Other features and advantages of the invention will appear on reading the detailed description of the embodiments of the invention, given by way of example only, and with reference to the drawings, which show:

FIG. 1 shows a diagram of an architecture using several modular battery packs placed in parallel by the junction bars 3 and 2).

FIG. 2 shows a diagram of a mixed series-parallel architecture

FIG. 3a shows a diagram of a three-card management circuit surrounding a four-cell modular series-connected battery pack according to the invention.

FIG. 3b shows a section of a four-cell modular series-connected battery pack according to the invention.

FIG. 3c shows a section of a perspective view of one face of a four-cell modular series-connected battery pack according to the invention.

FIG. 3d shows a section of a perspective view of an opposite face of a four-cell modular series-connected battery pack according to the invention.

FIG. 4a shows a diagram in perspective of a modular battery pack with eight cells according to the invention.

FIG. 4b shows a diagram in perspective of a battery formed from the parallel assembly of three modular series-connected battery packs according to the invention.

FIG. 5 shows a perspective diagram of a modular battery pack according to the invention.

FIG. 6 shows the diagram of a circuit carrying out the management function of a modular series-connected lithium battery according to the invention.

FIG. 7a shows an embodiment of the detection circuit by voltage measurement of the conditions (of short-circuit, overcurrent and deep discharge) to trigger the cut-off (disconnection) of the modular battery pack from the association with the other battery packs.

FIG. 7b shows another embodiment of the detection circuit by voltage measurement of the conditions (of short-circuit, overcurrent and deep discharge) to trigger the cut-off (disconnection) of the modular battery pack from the association with the other battery packs.

FIG. 8 shows an embodiment of the cut-off circuit effecting the cut-off in the event of discharge below a threshold or during a short circuit detected by the detection circuit.

FIG. 9 shows an embodiment of the circuit effecting a cut-off in the load in the event of overshoot, of voltage or of temperature, detected by the detection circuit of the management function.

FIG. 10a, FIG. 10b, FIG. 10c and FIG. 10d respectively show the display of changes in the voltage at the terminals of the comparators U1 and U2 in the event of overcurrent (4 A) according to one embodiment for a 24.4 Volt battery and a trigger voltage T_{d} of 16 Volts.

### DETAILED DESCRIPTION OF AN EMBODIMENT OF THE INVENTION

Various embodiments of the invention will now be described with reference to the figures, which are illustrative and not limiting, of the present application.

The solutions proposed until now describe external modular architectures where several batteries are coupled to an external data bus allowing information to be escalated to a supervisor.

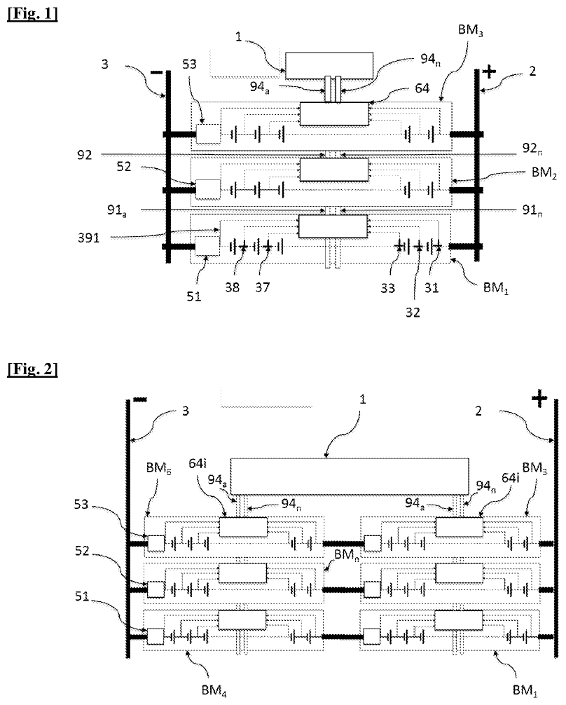

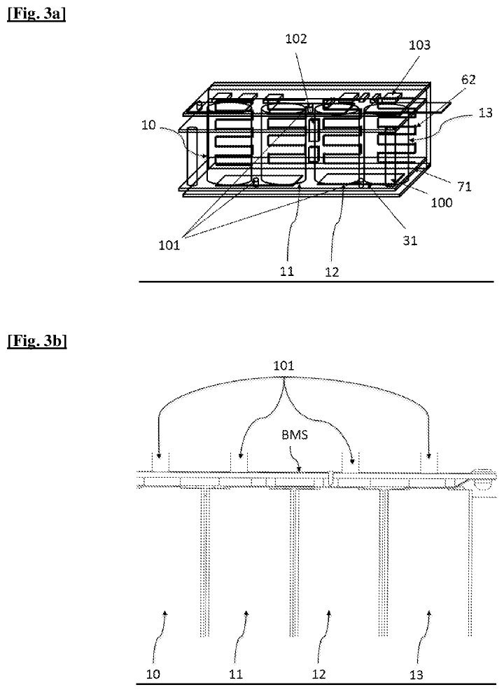

The architecture proposed by the invention is on the contrary internal to the battery, and can be a parallel modular architecture, as shown for example in [FIG. 1], or a serial modular architecture, as shown for example in [FIG. 2].

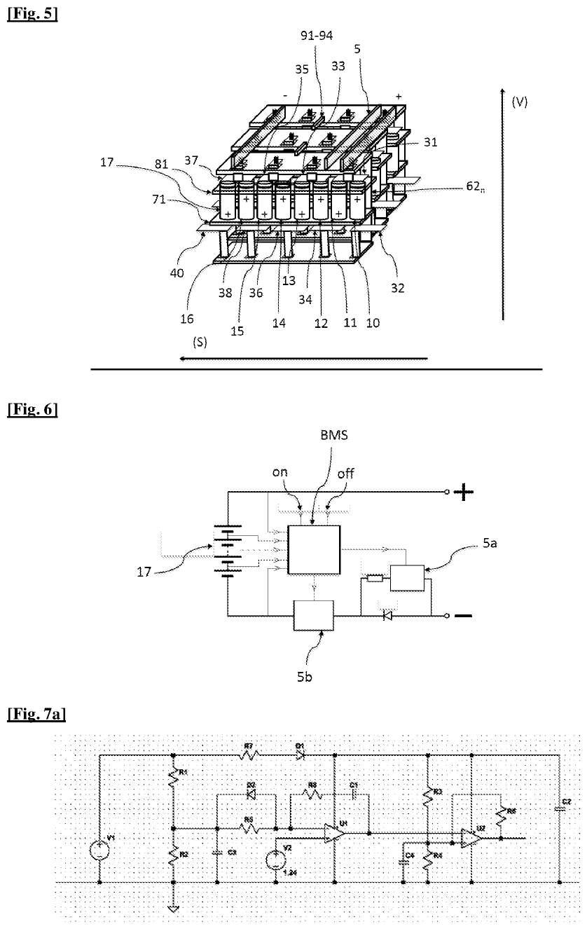

In certain embodiments, the modular series-connected battery pack is made up of cells (10, 11, 12, 13, 14, 15, 16, 17, [FIG. 5]) of lithium batteries with the same characteristics connected in series by connections in a given direction (S) corresponding to the direction of the currents to obtain the necessary voltage, as shown for example in [FIG. 1] to [FIG. 5].

In certain embodiments, the modular series-connected battery pack comprises, in the same direction S, a pair of upper (81) and lower (71) holding elements for holding adjacent cells (10, 11, 12, 13, 14, 15, 16, 17) and perpendicular to the direction (S) in a vertical direction (V) from bottom to top of the sheet, as shown for example in [FIG. 4a], [FIG. 4b] and [FIG. 5].

In some embodiments, wide tongues (31-40) connecting, on each upper or lower face of the module, each pair of adjacent cells (10, 11, 12, 13, 14, 15, 16, 17) mounted in series each with the next by their poles of opposite polarity, in the direction (S), ensure the connections between the battery cells (10, 11, 12, 13, 14, 15, 16, 17), said each upper, respectively lower, face being offset by one cell on the other lower, respectively upper, face, as shown for example in [FIG. 5]. In this figure, the first cell on the right has its positive pole positioned upwards adjacent to the upper bezel (81), while the last cell on the left of the series assembly has its positive pole positioned downwards, i.e. toward the lower bezel (71). Thus, as shown, the poles of each adjacent cell of a modular series-connected battery pack are mounted with the orientations of the poles alternating.

In certain embodiments, the connections are also connected to a processing circuit for measuring the potentials of each cell, the circuit being mounted on a printed circuit assembly forming three surfaces arranged in a U. As explained previously in the present application, said U-shaped assembly (formed by the three surfaces) being arranged so that the normal to the central surface or central part of the U, among said three surfaces, is perpendicular to the direction (S) and the vertical direction (V) (see [FIG. 4a]). Said U-shaped assembly surrounds the modular battery assembly on three sides. The upper part (outer face) of the central part of the U comprises the electronics of the management system (BMSₙ) of the modular battery pack (BIMoSe). For example, and without limitation, several modular battery packs can be assembled to form a battery in which the central surfaces or central parts of each U-shaped assembly are connected to each other by connectors (92-94), as shown for example in [FIG. 4b].

The central part of the U, arranged vertically (in the direction V), comprises the heating resistors of the modular battery pack and these resistors are connected on command from the management circuit to one or more battery cells (10, 11, 12, 13, 14, 15, 16, 17) of the modular battery pack for their supply.

The lower part of the U arranged under the cells (10, 11, 12, 13, 14, 15, 16, 17) contributes, with the upper part of the U, to recovering the potentials of each of the cells (10, 11, 12, 13, 14, 15, 16, 17) of the modular battery pack in order to supply them to the voltage management circuit of the modular battery pack management system.

The number of electric batteries on the line is chosen from 1 to X, X being the number making it possible to obtain the desired voltage for the modular battery pack from the voltage of each cellular element. The maximum voltage having to be borne by the electronic components, as shown for example in [FIG. 7] to [FIG. 9], in question.

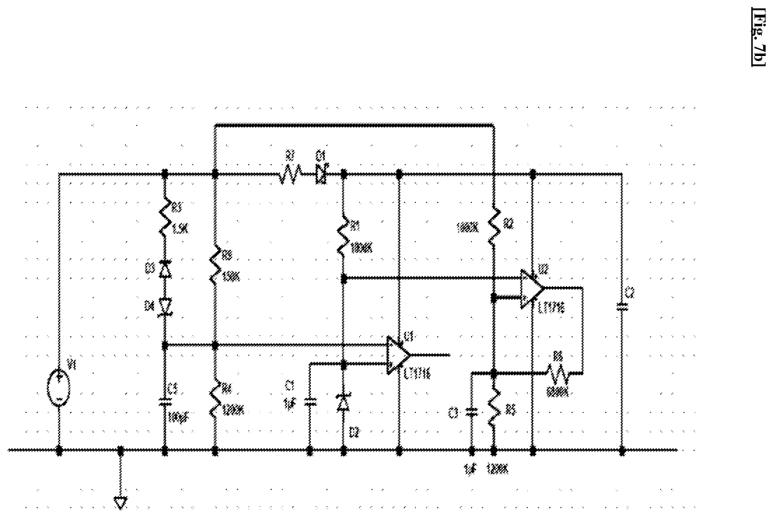

As shown in [FIG. 1] as an example, several modular series-connected battery packs BM1 to BM3 can be connected in parallel. There can be as many modular series-connected battery packs (BIMoSe) placed in parallel as the communication protocol between the circuits allows. Each management circuit (64) of a modular battery pack controlling the disconnection circuit (51 to 53) of a set of cells (10, 11, 12, 13, 14, 15, 16, 17) of a battery pack and receiving, on the voltage detection and control circuit of [FIG. 6] and [FIG. 7] of each cell of a modular battery pack via the connections (31 to 38), the voltage across the terminals of each cell (10, 11, 12, 13, 14, 15, 16, 17).

It is also possible to put as many BIMoSe in series as one wishes as long as the components support the voltage, as shown for example in [FIG. 2].

[FIG. 2] shows an example diagram of a mixed series-parallel architecture using several pairs of modular battery packs associated in series (BM3 with BM6; BM1 with BM4, respectively) to each form a stage and each stage being connected in parallel by the power contact bars (3, 2), thus constituting a battery with different technical characteristics. The reader will understand that from a modular series-connected battery pack whose number of unit elements can vary, various modular series-connected battery packs of different voltages can be produced, and that by assembling several modular series-connected battery packs of the same voltage in parallel, it is possible to obtain batteries delivering currents of different values.

In some embodiments, the central part (64) of the modular battery pack comprises temperature probes and a thermostat (102) in addition to the heating resistors (62). The temperature probes and the thermostat are connected to the temperature measurement circuit of [FIG. 6]. The heating resistors (62) are connected to the heating control circuit of the BMS management function of [FIG. 6].

The management function allows, at least from the voltage and temperature measurement, module monitoring, balancing of the cells (10, 11, 12, 13, 14, 15, 16, 17) and tripping breaking action on a discharge breaking device (5b) or on a load breaking device (5a).

In certain embodiments, the open/closed contact of a switching device (5) is connected on the one hand to the positive or negative pole of each last battery cell of a modular battery pack and on the other hand to the positive or negative lug, respectively, of the battery, the switching device (5) being a MOSFET or an electromagnetic element, as shown for example in [FIG. 1] to [FIG. 4b].

In certain embodiments, each BMS management card comprises a digital bus (94ₙ) and an analog bus (94ₐ) that are connected to a connector allowing the buses of a plurality of management cards BMSₙ belonging to a plurality of modular battery packs (BIMoₙ) to be connected together, then with a supervisor system (1) of all of the plurality of modular battery packs, as shown for example in [FIG. 1] and [FIG. 2].

In certain embodiments, the number of cells (10, 11, 12, 13, 14, 15, 16, 17) in series on a line is to be chosen from 1 to X depending on the desired voltage, the desired maximum voltage being supported by the components (103) used in the switching device (5) or the BMS card.

In certain embodiments, the holding elements (71, 81) are bezels held by spacers (100) and delimiting a set of cylindrical housings with a square or polygonal section defining, on each upper or lower bezel, a line of housings each receiving a cell;

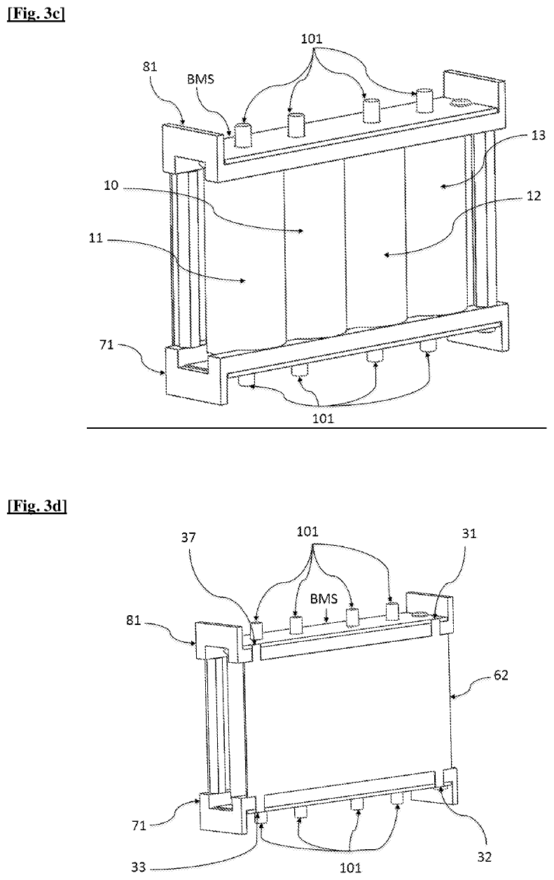

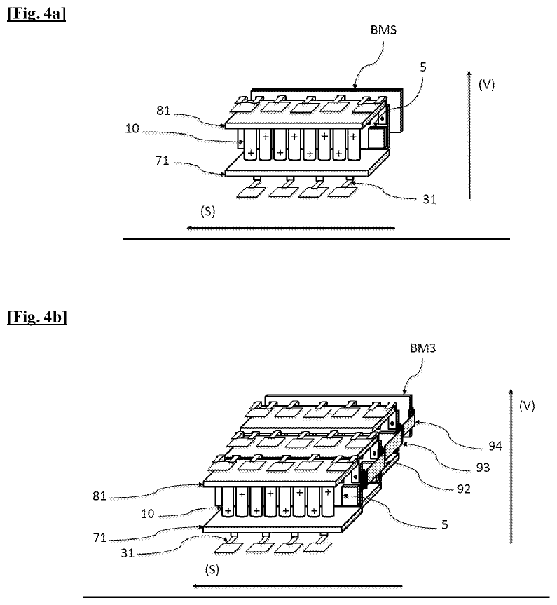

In certain embodiments, the tongues form, with Pogo pins (101), a T whose central bar constitutes the connection between with the processing circuit for recovering potentials via the upper and lower card, as shown for example in [FIG. 1] and [FIG. 3a] to [FIG. 3d].

The invention also relates to a series-parallel battery using modular series-connected battery packs, a plurality of modular series-connected battery packs are assembled in a row side by side and interconnected by two power bars, one of which is connected to each of the positive poles of each modular battery pack and to the negative outer lug of the battery box, and an inter-card connection (91 to 94, respectively) makes it possible to link the buses of each card together to form a series-parallel battery connected to an internal supervisor (1) in the battery box consisting of a microprocessor and an application program connected to other equipment by connectors.

In certain embodiments, on detection of too high a temperature of a module by the BMS management card (64) of a modular battery pack, the latter controls the disconnection of the electric battery row concerned by opening the switching device (5) to create a degraded current operating mode for the series-parallel battery assembly, and the supervisor (1) sends an alert message to the user (vehicle driver or pilot); then, if the temperature of the module decreases after opening the circuit, information on the drop in temperature is sent to the user to allow the battery to remain functional, without the series-parallel battery voltage being changed.

In certain embodiments, the switching device (5) is connected to a bar connected to a pole line, adjacent to the positive pole of the assembly, this bar acting as a passive radiator for discharging the heat from the cells (10, 11, 12, 13, 14, 15, 16, 17) by its dimensions chosen accordingly.

In certain embodiments, the disconnection device (5), shown for example in [FIG. 8] and [FIG. 9], is connected on the one hand to the negative or positive pole of each set of cells (10, 11, 12, 13, 14, 15, 16, 17) or each battery, and on the other hand to the negative, respectively positive lug and uses at least two MOSFETs M1, M2; one, M1, with an assembly for limiting its switching speed and with protection of its gate by a Zener diode connected in opposition between the gate and the source, performing the cut-off in the event of discharge below a threshold or when a short circuit is detected by the management circuit (64); the other, M2, performing a cut-off when the management circuit (64) detects a voltage or temperature overshoot by an element, an assembly around M2 also performing a current limitation at load.

In certain embodiments, the first MOSFET M1 is connected by its source to the negative terminal of a set of cells (10, 11, 12, 13, 14, 15, 16, 17) or unitary elements. Said MOSFET M1 receives, on its gate, a voltage source (V2) that drives M1, said source delivering a chosen voltage (for example 6 to 10 V) so that M1 is on, a Zener diode D3, connected in opposition between the gate and the source of M1, and a capacitor C2 protect the gate of the MOSFET from excessively high or high-frequency voltages, and a Zener diode D1 mounted in opposition between the gate of M1 and the drain and in series with a resistor R3 and a diode D2 in the forward direction in the drain-to-gate direction, D1, D2 and R3 limiting the switching speed of M1 and a circuit consisting of a diode (conventional) or a Schottky diode D4 limits the load current, this Schottky diode D4 is mounted in opposition on the drain of M1 in the charging direction, and in series with a capacitor C1 and a resistor R1 connected to the positive terminal of the battery to also limit the overvoltage when opening M1, in parallel on the Schottky diode D4 a fixed resistor 11 is mounted that is connected on the one hand to the cathode of the diode and on the other hand to the drain of the second MOSFET M2 whose source is connected to the anode of the Schottky diode D4, the gate of M2 being controlled by an output of the detection circuit to prevent or cut off the load.

In certain embodiments, the second MOSFET M2 ([FIG. 9]) is connected by its gate to the base of the phototransistor of an opto-coupler whose emitter is connected to the source of M2; between these two points, a Zener diode D5 and a capacitor C5 are connected by the BMS card; the light-emitting diode of the opto-coupler is connected by its cathode to the negative terminal of the battery or of the modular set of cells (10, 11, 12, 13, 14, 15, 16, 17) and receives, on its anode, the command from the BMS detection circuit sending a current into the LED in case of detected voltage or temperature overshoot of an element.

In certain embodiments, for a 12 V, 15 Ah battery, the series-parallel battery is made up of m rows of modular series-connected battery packs connected in parallel, each of the modular battery packs being made up of n lithium cells (10, 11, 12, 13, 14, 15, 16, 17) assembled in series (nSmP), nS designating the number of series electric accumulators and mP designating the number of parallel lines, as shown for example in [FIG. 1].

It should be noted that the measurement principle of the BMS function is to refrain from current measurement. The principle therefore consists in taking, from the terminals of each cell or series-connected block of cells (10, 11, 12, 13, 14, 15, 16, 17), a proportion of the overall voltage V of each cell or of each series-connected set of cells (10, 11, 12, 13, 14, 15, 16, 17). Thus, each cell or series-connected battery pack pole is connected on the one hand to one end of a divider bridge consisting of resistors (R1, R2), and connected by its other end to the other cell or block pole modular series-connected battery pack. The proportional voltage taken from the common point of the resistors is used, either analogically by a comparator supplied on its other terminal by a reference voltage, or digitally by an integrator assembly as explained below.

The principle of measurement via an integrator circuit as described in the present application is a principle of measurement of an overall voltage that makes it possible to trace back to a current value. This principle is only valid in the battery field when the internal resistance of the voltage generator is known. In this case and only in this case, said integrator circuit can be used either in analog (as shown in [FIG. 7]) or digital (not shown).

For example, and without limitation, the response or output of a digital integrator can be calculated as follows:

Consider a voltage variation represented by x=(−0.25*V_{global}+2.5)*weighting, where V_{global} is a voltage obtained from the battery voltage by the use of a voltage divider bridge (R1-R2 or R9-R4) and “weighting” is a variable that allows the integration constant to be changed. The above equation can be modified according to the batteries used.

The output or response, y, of the numerical digital integrator having the general form y=Integration(x), where Integration( ) represents the integral calculus, can be calculated using either as a first progressiveness equation consisting in taking the value of x, defined above, and raising it to an even power (2, 4, 6, 8, etc.), for example y=x².

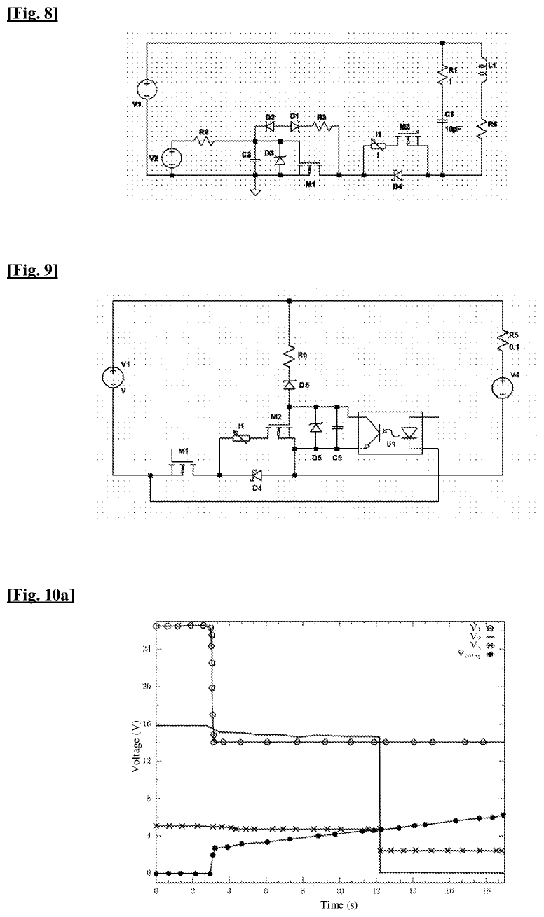

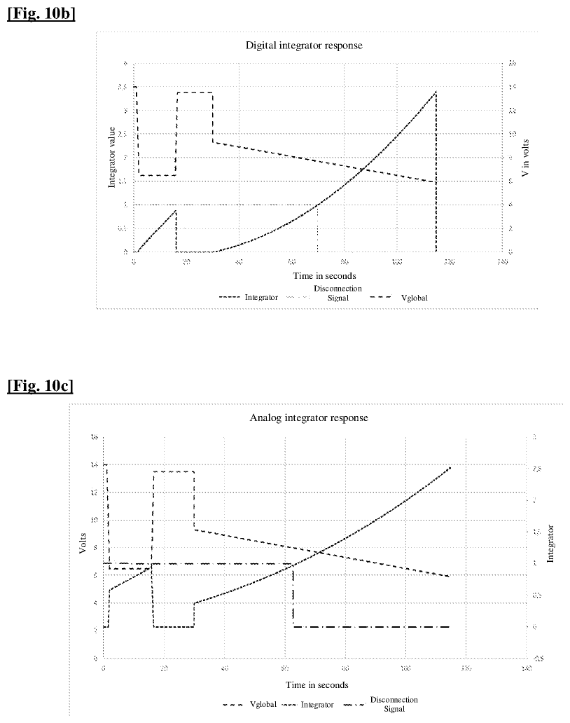

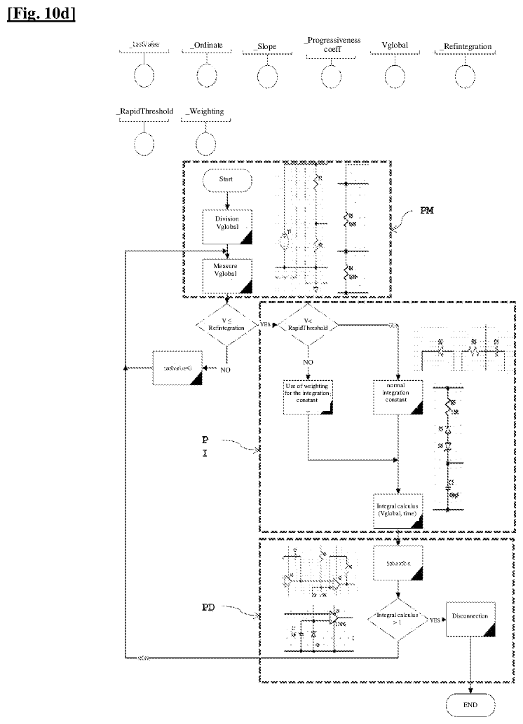

To get even closer to the analog integrator, a second progressiveness equation defined, for example and in non-limitingly, by y=Rate*(−ln(x)), with Rate, an integration constant expressed in seconds, can be used. This equation makes it possible to imitate the behavior of a capacitor whose terminal voltage evolves like an exponential, as shown for example in [FIG. 10a] and [FIG. 10c].

A flowchart explaining the program for calculating the response of a digital integrator assembly according to an embodiment with paralleling of the analog embodiments is shown for example in [FIG. 10d], which shows a diagram for calculating the response of a digital integrator according to the second progressiveness equation. Each calculation step represents the components of the detection device that can be involved in the calculation operations. The diagram can be divided into three phases: a measurement (PM) and comparison phase, an integration phase (PI) and a disconnection phase (PD).

In the measurement phase (PM), the voltage divider bridge R1-R2 (or R9-R4, [FIG. 7b]) makes it possible to determine a measurement V=Vglobal of the voltage at the input of the detection device from the voltage V1 of the battery.

The “Ref_{integration}” variable is the integration reference and corresponds to a voltage value below which the input signal V will be integrated. If the voltage V is greater than the “Ref_{integration}” variable, the battery is in a situation of normal operation. If V is less than the “Ref_{integration}” variable, the battery is operating abnormally and the process that can lead to the disconnection of said battery is triggered. This variable Ref_{integration} is therefore equivalent to the reference voltage V2. One then enters the integration phase, where the response of the integrator must be calculated.

If the voltage V is lower than the “Ref_{integration}” variable, the program triggers either the use of a normal integration constant in the calculation performed, or the use of weighting for the integration constant. This weighting as represented in the PI box is used if the voltage is lower than a second comparison variable called “RapidThreshold,” which makes it possible to define a voltage threshold from which the “weighting” variable (defined above) is used in the calculation of the voltage variation or not. For example, and non-limitingly, the voltage variation has a general form of type x=(slope*Vglobal+ordered)*weighting.

If the difference or variation of the input voltage V, dV, between a time t1 and a time t2 (or between two successive measurements of the voltage V), defined by dV=|V(t2)−V(t1)|, is greater than the “RapidThreshold” variable, the “weighting” variable takes the value 5, for example. If, on the contrary, said difference or variation of the voltage V, dV, is less than the “RapidThreshold” variable, the “weighting” variable takes the value 1. Which corresponds to using a normal integration constant.

The voltage measurement time pitch can be comprised, for example and non-limitingly, between 1 ms to 100 ms. The value of the “RapidThreshold” variable can be defined according to the measurement time pitch and by monitoring the voltage variation between two times t1 and t2, corresponding to said time pitch, used to perform the voltage measurements, in order to improve the conditions for detecting abnormal conditions. For example, and non-limitingly, for FIG. 4B, the measurement time pitch used is 10 ms and the “Rapid Threshold” value is 0.01 Volt. This corresponds to a voltage drop dV=0.01 Volt every 10 ms.

The “Ordinate” and “Slope” variables obtained by memorizing the measurement points and calculating, for example by fitting the memorized voltage data or by using two points of the memorized voltage curve between two times t1 and t2 to deduce the “slope” (for a linear voltage variation) then the “ordinate,” make it possible to define the voltage variation. In the example where x=(−0.25*Vglobal+2.5)*weighting, the slope is −0.25 and the ordinate is 2.5.

The step of comparing the voltage variation dV is equivalent to a step of comparing the calculated slope with the stored “Rapid Threshold” value, i.e., if the slope exceeds the “Rapid Threshold” value, applying a weight coefficient (for example, 5) increasing the acceleration of the evolution of the integral so that it crosses the trigger voltage threshold Td more quickly, or if it is not exceeded, a weight coefficient without acceleration effect (for example, 1).

Once the voltage variation is obtained, the signal is integrated according to the second progressiveness equation, for example. The output signal thus corresponds to the integration of the input signal.

The “Progressiveness coeff” variable corresponds to an integration constant (Rate in the second progressiveness equation).

In the embodiment by digital integrator, those skilled in the art will understand that the assembly using the comparators U1 and U2 is replaced by a microprocessor playing the role of a digital comparator (Un). Said microprocessor is equipped with a storage memory allowing the storage of the “Ref_{integration}” and “Rapid Threshold” threshold variables and the “Ordinate” and “Slope” calculation variables defined according to these thresholds.

As shown for example in [FIG. 10b], the response of a digital integrator assembly operates according to a flowchart, for example the flowchart shown in [FIG. 10d], according to an embodiment used with a 16 Volt battery and a trigger voltage Td of 12 Volts.

The memory also contains the calculation program allowing the collection of the voltage curve points (V_{global}, . . . ), the comparisons and decisions, the implementation of the equations, the integration and the decisions represented in the flowchart of [FIG. 10b]. As input, the digital circuit only receives the voltage V_{global} from the common point of a divider bridge between a resistor R1 and a resistor R2 and performs measurements according to a determined frequency to observe the voltage V_{global} curve, then from the detection of the crossing of the “Ref_{integration}” threshold, which, in the example shown in [FIG. 10b], is chosen to be less than 3 volts per cell element or 12 volts for a battery of 4 cell elements in series from this reference voltage V2, the microprocessor program triggers the calculations to obtain the comparison with the “Rapid Threshold” variable of the variation dV of the voltage V_{global} between two successive instants t1 and t2 (or between two successive measurements) in order to determine the use or not of a “Weighting” variable. Thus, in the case of a start causing a significant drop in voltage from 14 to almost 6 Volts, the “RapidThreshold” variable is, for example and non-limitingly, set at 0.01 Volt in the example shown in [FIG. 10b]. The “Rapidthreshold” variable will be crossed and the integration will be done with weighting to avoid an excessively fast cut-off preventing starting. On the diagram shown in [FIG. 10b], it is observed that the battery voltage having dropped rapidly to almost 6 Volts and remaining constant for about 18 seconds, the digital circuit integrates the constant value in a straight line, which remains below the detection or trigger voltage Td, which is chosen at 1 Volt. The response of the integrator or output voltage can, for example and non-limitingly, be obtained with a program such as the one defined in the appendix to this application where the “General Voltage” variable corresponds to the voltage V_{global} at an instant t1=t, and the “LastGeneralVoltage” variable represents the value of the voltage V_{global} at instant t2=t−1. The “ORDINATE_ORIGIN” variable corresponds to the “Ordinate” variable defined above and the “lastIntegratedValue” variable corresponds to the integral calculation or the integrator's response.

The calculation of the integral or of the integrator's response can comprise taking into account the “Slope and/or Ordinate” variables calculated by the microprocessor from the data of the recorded voltage curve V_{global}.

Integration is triggered as soon as the overall voltage V_{global} drops below V2=Ref_{integration}=9 Volts.

Then, during its use, the voltage of the battery drops suddenly from 14 Volts to about 9 Volts, then decreases slowly over time along a straight line down to 6 Volts. The ordinate of the line is approximately 2.3 Volts and the slope is lower than previously, and the variation dV of the voltage between two successive measurements may be greater (depending on the value of the slope) than the “Rapidthreshold” variable (for example, 0.01 Volt in the example shown in [FIG. 10b]).

When the value at the output of the integration reaches the threshold corresponding to the detection or trigger voltage Td of 1 volt, the cut-off is triggered.

Finally, in the digital version or variant, during a short circuit, the voltage V_{global} drops very quickly to a very low value, a short circuit detection threshold is stored, and as soon as the program executed by the processor detects the crossing of this threshold, it activates the disconnection signal.

FIG. 10b illustrates the response or output signal of a digital integrator according to the example described above. The digital integrator exhibits behavior that is similar to that of an analog integrator, as shown for example in [FIG. 10c], in the time interval comprised between t=40 s and approximately t=120 s, with a 16 volt battery and a trigger voltage T_{d} of 12 volts.

In the disconnection phase, the calculation of the response is used to check whether a disconnection should be triggered (or activated) or not. Disconnection is activated when the response of the integrator is greater than a given threshold corresponding to the detection or trigger voltage Td. In the example above, illustrated by [FIG. 10b], [FIG. 10c] and [FIG. 10d], this threshold is set at approximately 1 or 1.24 volts. For example and non-limitingly, the threshold value can be normalized to 1.

Thus, the BMS comprises at least one deep discharge, overcurrent and short circuit detection device in each unitary element or modular assembly of the battery and comprises at least one BMS device, the detection device being unique and comprising a comparator U1 that directly compares a proportional voltage, in a determined ratio, with that of the unitary element or of the modular assembly, without using a resistive shunt, in order to compare it with a reference voltage V2 to activate or not activate the disconnection of the battery according to the variations of the voltage of the unitary element or of the modular assembly; the proportion ratio between the measured voltage and the reference voltage corresponds to the ratio between the reference voltage V2 and the trigger voltage T_{d} from which the disconnection device is actuated.

In a variant of the BMS, a microprocessor equipped with at least one storage memory allows the storage of at least one “Ref_{integration}” threshold variable and of a stored detection voltage value T_{d}; the memory also contains the program executed by the microprocessor allowing the collection of the points of the voltage curve V_{global}, the comparisons of the voltages V_{global} with “Ref_{integration}” and of the calculated voltage integral (V_{integ}) with T_{d} and decisions, the implementation equations allowing the integration, the microprocessor receiving as input the voltage V_{global} coming from the common point of a resistor divider bridge connected between the two poles of the cell or of the set of cells (10, 11, 12, 13, 14, 15, 16, 17) and storing the measurements according to a determined frequency to observe the voltage curve V_{global}, and compare the values of the voltage curve V_{global} to the “Ref_{integration}” value, then when crossing of the “Ref_{integration}” threshold is detected, said threshold being defined by the value stored in the memory, triggering the integration calculations of the curve V_{global} and comparing the values of the calculated integration curve (V_{integ}) with a stored detection voltage value T_{d} to activate the disconnection device performing the cut-off.

According to a variant, the memory also comprises the value of a “RapidThreshold” variable stored in order to determine, by comparing the instantaneous voltage V_{global} with the “RapidThreshold,” whether the calculation of the integral of the voltage curve V_{global} must take a weighting coefficient into account.

According to another variant, the calculation of the integral can take into account the “Slope and/or Ordinate” variables, calculated by the microprocessor from the data of the recorded voltage curve V_{global}.

In certain embodiments, the BMS management function comprises a detection device, as shown for example in [FIG. 7], which is unique, comprising a comparator U1 that directly compares a proportional voltage, in a determined ratio, to that of the unitary element or of the modular assembly, without using a resistive shunt, to compare it to a reference voltage V2 to activate or not activate the disconnection by the disconnection circuit (5) of the cell or of the group of cells (10, 11, 12, 13, 14, 15, 16, 17) according to the variations of the voltage of the individual element or of the modular assembly; the proportion ratio between the measured voltage and the reference voltage corresponds to the ratio between the reference voltage V2 and the trigger voltage Td from which it is chosen for the disconnection device to be activated.

In another embodiment, the detection device, shown for example in [FIG. 7a, FIG. 7b], comprises, at least around one comparator U1, a divider bridge (R1, R2, or R9, R4) mounted between the terminals of the modular assembly of the battery or of a unit cell of the battery whose common point with the resistors is connected to the input of the negative terminal of the comparator U1 to supply a voltage whose value is proportional to the voltage value V1 at the terminals of the battery, in the ratio defined by the values of the two resistors (R1, R2 or R9, R4), and the positive terminal of the comparator is connected to a diode or a supply cell (not shown) to define the reference voltage V2.

In another embodiment, an integrator assembly, shown for example in [FIG. 7a], comprises a resistor R5 connected between the common point of the divider bridge R1, R2 and the negative input of the comparator U1, and a resistor R8, capacitor C1 set connected in series by a common terminal is connected by the other terminal of C1 to the output of the comparator U1 and the other terminal of R8 is connected to the common point of the two resistors R5, R8 and to the negative input of U1; the values R5 and C1 are adjusted to set the intervention time of the disconnection before the deterioration of the battery in the event of overcurrent detection.

In another embodiment, the detection device comprises a capacitor C3, shown for example in [FIG. 7], mounted in parallel with R2, which, combined with R1, forms a filter to filter out high-frequency disturbances and set a minimum disconnection time.

In another embodiment, a comparator circuit U2, shown for example in [FIG. 7a], with hysteresis, disposed downstream of the comparator circuit U1, comprises a hysteresis assembly around the amplifier U2 that receives, at the input of its negative terminal, the value of the voltage of the output of the amplifier U1.

The invention also relates to a set of series-parallel batteries, the cells (10, 11, 12, 13, 14, 15, 16, 17) of which are selected lithium elements of 3.3 V each and 2.5 Ah. In certain embodiments, each module of the modular series-connected battery pack comprises a set of three interconnected electronic cards, ensuring a BMS management function extended to have at least one or more of the following features in so-called normal operation:

Cell voltage balancing (10, 11, 12, 13, 14, 15, 16, 17);

Comparison of the voltage thresholds of each electric battery;

Supply of electric battery heaters (62n) in case of negative temperature;

Module temperature measurement managed by the BMS card;

Protection against short circuits by short circuit detection and protection against a slow and deep discharge by slow and deep discharge detection, and opening of the switching device (5) consisting either of at least one MOSFET, or of an electromagnetic element;

Limitation of the charging current by opening of the MOSFET participating in the charging circuit so as to preserve the longevity of the electric batteries;

Calculation of the state of charge and health of the electric batteries;

Dialog with the circuit to send it the following information:

Alert;

SOH;

ON;

OFF;

Or to execute the following orders received from the supervisor:

ON;

OFF;

Starting the heater (62ₙ).

In certain embodiments, when the supervisor (1) detects a fault in the balancing of the currents between modules via observation by the supervisor (1) of an electric battery line (17) with a current out of limit, an excessive difference with respect to the others indicating that this line is fatigued, the supervisor triggers the sending of a “maintenance” message from the battery to the driver of the vehicle or to the pilot, allowing the state of the battery to be checked and a breakdown to be avoided.

In certain embodiments, the card implementing the management functions (BMS) has the following reaction time characteristics:

Detection of a short circuit: opening time of 75 ms;

Detection of the maximum admissible current: opening time of 10 seconds;

Detection of a discharge corresponding to 10° C.: 10 times the capacity of the battery, that is to say, for a 10 Ah battery, the discharge is at 100 Ah and the circuit opening time is 5 minutes 30 seconds;

Detection of a discharge corresponding to 1° C.: the circuit opening time is 60 minutes.

In certain embodiments, each BMS card integrates temperature monitoring that remains constantly active, even if the battery is “OFF,” by analyzing the temperature in the battery envelope via the supervisor, measured by a probe (not shown) mounted on the central part (62n) of the cards of each module supporting the heating resistors (62), this probe being associated with an electronic assembly (not shown) serving to warn via a message on an LCD screen or by an audible beep, even when the battery is on the shelf.

In certain embodiments, to limit the charging current, each BMS card uses a component of the resistor type, which is conductive in the direction of discharge of the battery and resistive like a diode connected in opposition in the direction of charge.

The invention therefore provides, in a modular architecture, one or more BMS management circuits internal to the battery, monitoring all the electric batteries at the same time from the voltages, without multiplying the wiring.

```
  Annex:
  This corresponds to a non-limiting example of a digital integrator program to
implement the response of the integrator in Fig. 10b:
floatlastIntegratedValue = 0;
constfloat_SLOPE = −0.25;
constfloat _ORDINATE_ORIGIN = 2.5;
constfloat _COEF_PROGRESSIVENESS = 1;
constfloat _VALUE_REF_INTEGRATION = 10;
constfloat _RAPID_THRESHOLD=0.01;
constfloat_WEIGHTING=1;
loop( ){
      floatGeneralvoltage = IO_Voltage(1) * 7;// recovery of the battery voltage that
has been divided and rescaled
      lastIntegratedValue = Integration(generalvoltage, lastIntegratedValue);
      if (lastIntegratedValue>= 1 ) Disconnection ( );
}
floatIntegration (floatGeneralvoltage, floatlastValue){
      if(generalvoltage<= _VALUE_REF_INTEGRATION){
            if ((LastGeneralVoltage - generalVoltage)>_RAPID_THRESHOLD ||
      (LastGeneralVoltage - generalVoltage)< -_RAPID_THRESHOLD)
            _WEIGHT = 5;
else
            _WEIGHT = 1;
      float x = (_SLOPE * generalvoltage + _ORDINATE_ORIGIN)*_WEIGHT;
      float y = integration(x, _COEF_PROGRESSIVENESS);
int value = lastValue + y;
return value;
      }
return 0;
}
```

1. Modular series-connected battery pack (BIMoSe) consisting of lithium battery cells (10, 11, 12, 13, 14, 15, 16, 17) arranged in a vertical direction (V); these cells (10, 11, 12, 13, 14, 15, 16, 17) with the same characteristics are connected in series by connections in a given direction (S) corresponding to the direction of the currents to obtain the necessary voltage, characterized in that the modular series-connected battery pack comprises, in the same direction (V), a pair of upper (81) and lower (71) holding elements for holding adjacent cells (10, 11, 12, 13, 14, 15, 16, 17) and perpendicular to the direction (S);
wide tongues (30ₙ) connecting, on each upper or lower face of the module, each pair of adjacent cells (10, 11, 12, 13, 14, 15, 16, 17) mounted in series each with the next by their poles of opposite polarity, in the direction (S), ensure the connections between the battery cells (10, 11, 12, 13, 14, 15, 16, 17), said wide tongues of each upper, respectively lower, face being offset by one cell on the other lower, respectively upper, face;
the connections being also connected to a processing circuit for measuring the potentials of each cell, the circuit being mounted on a printed circuit assembly forming three surfaces arranged in a U, said U-shaped assembly enveloping the modular battery assembly on three sides, said U-shaped assembly being arranged so that the normal to the central part of the U is perpendicular to the direction (S) and to the vertical direction (V), and
the outer face of the central part of the U comprises the electronics of the management system of the modular battery pack (BIMoSe);
at least one BMS (Battery Management System), forming the central part of the U, arranged vertically, comprises the heating resistors (62) of the modular battery pack and these resistors are connected on command from the management circuit to one or more battery cells (10, 11, 12, 13, 14, 15, 16, 17) of the modular battery pack for their supply;
The lower part of the U arranged under the cells (10, 11, 12, 13, 14, 15, 16, 17) contributes, with the upper part of the U, at least to recovering the potentials of each of the cells (10, 11, 12, 13, 14, 15, 16, 17) of the modular battery pack in order to supply them to the voltage management circuit of the modular battery pack management system.

2. Modular series-connected battery pack according to claim 1, characterized in that the central part comprises temperature sensors and a thermostat.

3. Modular series-connected battery pack according to claim 1 or 2, characterized in that the open/closed contact of a switching device (5) is connected on the one hand to the positive or negative pole of each last battery cell of a modular battery pack and on the other hand to the positive or negative lug, respectively, of the battery, the switching device (5) being a MOSFET or an electromagnetic element.

4. Modular series-connected battery pack according to one of claims 1 to 3, characterized in that each BMS card of each modular block comprises a digital bus and an analog bus that are connected to a connector allowing the buses of a plurality (n) of cards BMSₙ belonging to a plurality of modular series-connected battery packs (BIMoSeₙ) to be connected together, then with a supervisor system (SU) (1) of all of the plurality of modular battery packs.

5. Modular series-connected battery pack according to one of claims 3 to 4, characterized in that the number of cells (10, 11, 12, 13, 14, 15, 16, 17) in series on a line is to be chosen from 1 to X depending on the desired voltage, the desired maximum voltage being supported by the components used in the switching device (5) or the BMS card.

6. Modular series-connected battery pack according to claim 1, characterized in that the holding elements are bezels held by spacers and delimiting a set of cylindrical housings with a square or polygonal section defining, on each upper or lower bezel, a line of housings each receiving a cell;
The tongues form, with elastic pins, for example of the Pogo type (called pogo pin), a T whose central bar constitutes the connection with the processing circuit for recovering potentials via the upper and lower card.

7. Modular series-connected battery pack according to one of claims 3 to 6, characterized in that each module comprises a set of three interconnected electronic cards, ensuring a BMS function, for managing the elements of a modular battery pack, extended to have one or more of the following features in so-called normal operation:
Cell voltage balancing (10, 11, 12, 13, 14, 15, 16, 17);
Comparison of the voltage thresholds of each electric battery;
Supply of electric battery heaters in case of negative temperature;
Module temperature measurement managed by the BMS card;
Protection against short circuits by short circuit detection and protection against a slow and deep discharge by slow and deep discharge detection, and opening of the switching device consisting either of at least one MOSFET, or of an electromagnetic element;
Limitation of the charging current by opening the charging circuit so as to preserve the longevity of the electric batteries;
Calculation of the state of charge and health of the electric batteries;
Dialog with the circuit to send it the following information:
Alert;
SOH (State of Health, that is to say, the availability of energy from the battery);
ON;
OFF;
Or to execute the following orders received from the supervisor:
ON;
OFF;
Starting the heater.

8. Modular series-connected battery pack according to one of claims 1 to 7, characterized in that the BMS card has the following reaction time characteristics:
Detection of a short circuit: opening time of 75 ms;
Detection of the maximum admissible current: opening time of 10 seconds;
Detection of a discharge corresponding to 10° C.: 10 times the capacity C of the battery, that is to say, for a 10 Ah battery, the discharge is at 100 Ah and the circuit opening time is 5 minutes 30 seconds;
Detection of a discharge corresponding to 1° C.: the circuit opening time is 60 minutes.

9. Modular series-connected battery pack according to one of claims 1 to 8, characterized in that, to limit the charging current, each BMS card uses a component of the resistor type, which is conductive in the direction of discharge of the battery and resistive like a diode connected in opposition in the direction of charge.

10. Modular series-connected battery pack according to claim 9, characterized in that the replaceable component circuits are replaced by the use of a microcontroller in each module and of a supervisor (either implemented in one of the modules or on a separate card internal to the battery) to allow:
The implementation of innovative algorithms, even “machine learning or deep learning.”

11. Method of using a modular series-connected battery pack according to one of claims 1 to 10, characterized in that each BMS card integrates temperature monitoring that remains constantly active, even if the battery is “OFF,” by analyzing the temperature in the battery envelope via the supervisor, measured by a probe (102) mounted on the central part (62n) of the cards of each module to warn via a message on an LCD screen or by an audible beep, even when the battery is on the shelf.

12. Method of using a modular series-connected battery pack according to claim 11, characterized in that the BMS cards use:
A digital data bus to transmit signals between each module;
One or more communication protocols allowing:
Data monitoring of each module (balancing voltage, temperature, current);
Reporting of alerts;
Monitoring health status, state of charge.

13. Series-parallel battery using modular series-connected battery packs according to one of claims 1 to 10, characterized in that a plurality of modular series-connected battery packs (BIMoSe) are assembled in a row side by side and interconnected by two power bars, one of which is connected to each of the positive poles of each modular battery pack and to the negative outer lug of the battery box, and an inter-card connection (91 to 94, respectively) makes it possible to link the buses of each card together to form a series-parallel battery connected to an internal supervisor in the battery box consisting of a microprocessor and an application program and connected to other equipment by connectors.

14. Series-parallel battery according to claim 13, characterized in that the switching device (5) is connected to a bar connected to a pole line, adjacent to the positive pole of the assembly, this bar acting as a passive radiator for discharging the heat from the cells (10, 11, 12, 13, 14, 15, 16, 17) by its dimensions chosen accordingly.

15. Series-parallel battery according to claim 14, characterized in that for a 12 V, 15 Ah battery, the series-parallel battery is made up of m rows of modular series-connected battery packs connected in parallel, each of the modular battery packs being made up of n lithium cells (10, 11, 12, 13, 14, 15, 16, 17) assembled in series (nSmP), nS designating the number of series electric accumulators and mP designating the number of parallel lines, m and n being integers greater than or equal to zero.

16. Set of series-parallel batteries according to claim 14 or 15, characterized in that the selected cells (10, 11, 12, 13, 14, 15, 16, 17) are lithium elements of 3.3 V each and 2.5 Ah.

17. Method for using a series-parallel battery comprising a series-parallel battery according to claim 13, characterized in that on detection of too high a temperature of a module by the BMS card of a modular battery pack, the latter controls the disconnection of the electric battery row concerned by opening the switching device (5) to create a degraded current operating mode for the series-parallel battery assembly, and the supervisor sends an alert message to the user (vehicle driver or pilot); then, if the temperature of the module decreases after opening the circuit, information on the drop in temperature is sent to the user to allow the battery to remain functional, without the series-parallel battery voltage being changed.

18. Method according to claim 17 for using a series-parallel battery according to claims 13, 14 and 15, characterized in that when the supervisor detects a fault in the balancing of the currents between modules via observation by the supervisor of an electric battery line with a current out of limit, an excessive difference with respect to the others indicating that this line is fatigued, the series-parallel battery triggers the sending by the supervisor of a “maintenance” message from the battery to the driver of the vehicle or to the pilot, allowing the state of the battery to be checked and a breakdown to be avoided.
